(19) United States
(12) Patent Application Publication
(10) Pub. No.: US 2023/0384452 A1
(43) Pub. Date: Nov. 30, 2023

(54) OPTOELECTRONIC SENSOR FOR DISTANCE MEASUREMENT WITH A ROUTING LAYER

(71) Applicant: SICK AG, Waldkirch (DE)

(72) Inventors: Christoph MENZEL, Denzlingen (DE); Axel JAHN, Waldkirch (DE)

(21) Appl. No.: 18/203,637

(22) Filed: May 30, 2023

(30) Foreign Application Priority Data
May 31, 2022 (EP) 22176421.0

(51) Int. Cl. G01S 17/36; G01S 7/481; G01S 7/4915

(52) U.S. Cl. CPC G01S 17/36; G01S 7/4816; G01S 7/4915

(57) ABSTRACT

The invention relates to an optoelectronic sensor for distance measurement that comprises a light source that is configured to convert a transmission signal into transmission light and to transmit the transmission light into an environment. The optoelectronic sensor further comprises a light receiver that receives transmission light reflected by objects in the environment as reception light, wherein the light receiver has an optical routing layer, wherein the light receiver has an image sensor comprising a plurality of sensor elements, wherein the sensor elements are configured to convert reception light into reception signals, wherein at least two sensor elements are part of a sensor element group, wherein the routing layer is configured to supply the reception light successively and/or alternately to the sensor elements of the sensor element group. The invention further relates to a method for a corresponding optoelectronic sensor and to a method for manufacturing a corresponding optoelectronic sensor.

The present invention relates to an optoelectronic sensor for distance measurement comprising a routing layer as well as to a method for distance measurement and to a method for manufacturing a corresponding optoelectronic sensor.

Image sensors, which are, for example, used for 3D cameras, are often based on so-called time-of-flight (TOF) methods that determine a distance between a camera and an object based on a measured time required by a light beam that is transmitted by a light source, which is installed in the camera, to travel the distance back and forth between the camera and the object.

In such TOF methods, the achievable depth resolution is largely dependent on the modulation frequency used. An improved depth resolution can generally also be achieved at a higher modulation frequency. Consequently, the use of high modulation frequencies is desirable. To be able to process the higher modulation frequencies, the achievable modulation contrast is of decisive importance, e.g. when mixing the transmission and reception signal, wherein the modulation contrast indicates how well different portions of the reception signal can be distinguished from one another.

Conventional image sensors frequently comprise two electron pots in which generated electrons are “collected”. Light incident on a pixel generates photoelectrons, wherein an internal, rapidly modulated voltage ensures that the photoelectrons are “guided” in two different directions and are “collected” in a respective electron pot. Such a pixel that comprises two electron pots is, for example, called a 2-tap pixel or a lock-in pixel. At the end of a measurement time, it is measured how many electrons are in a respective pot. The function of describing the efficiency of redirecting the electrons into the respective pots can be designated as the modulation function, which depends on the modulation frequency. Its property is effectively described by the modulation contrast. The modulation contrast indicates what proportion of the photoelectrons in electronic mixers—or photons in non-electronic mixers—actually end up in the (electron) pot where they should. Ideally, the modulation function is a square wave function that jumps between 0 (or −1) and 1.

However, the modulation contrast of conventional image sensors decreases significantly at increasing frequencies so that an ideal depth resolution is not achieved, Furthermore, in conventional image sensors, which, for example, comprise lock-in pixels, the usable modulation frequency is limited by the transport speed of the charge carriers in the semiconductor.

Unsuccessful attempts exist in practice to periodically block the irradiation of an image sensor with received light and thus to enable a demodulation in order to permit the use of higher modulation frequencies for the corresponding image sensor. However, a significant portion of the received light is blocked in this respect and is thus not used so that the modulation contrast is degraded.

Therefore, an underlying object of the invention is to provide an improved optoelectronic sensor for distance measurement as well as a method for distance measurement for such an optoelectronic sensor and a method for manufacturing such an optoelectronic sensor.

This object is satisfied by the subjects of the independent claims.

The invention relates to an optoelectronic sensor for distance measurement, comprisinor
a light source that is configured to convert a transmission signal n o transmission light and to transmit the transmission light into an environment;
a light receiver that receives transmission light reflected by objects in the environment as reception light, wherein the light receiver has an optical routing layer,
wherein the light receiver has an image sensor comprising a plurality of sensor elements, wherein the sensor elements are configured to convert reception light into reception signals,
wherein at least two sensor elements are part of a sensor element group,
wherein the routing layer is configured to supply the reception light successively and/or alternately to the sensor elements of the sensor element group.

The invention is based on the realization that the reception light can be supplied by the routing layer to one sensor element of a sensor element group at a time, in particular in each case at least substantially to only one sensor element at a time, wherein a demodulation of the reception light can be performed in this way. If, for example, two sensor elements are present in a sensor element group, the reception light can e.g. be alternately supplied to the two sensor elements, whereby two reception signals can then preferably be generated that can be used to determine, for example, the phase (relative to the transmission signal), the amplitude and/or the intensity offset (likewise relative to the transmission signal) of the reception light. The time of flight to the objects can be determined in this way, at least indirectly.

The reception light can in particular be alternately and/or successively supplied to the respective sensor elements of the sensor element group within a modulation period, i.e. within a time duration of

$$\frac{1}{Modulation frequency} ,$$

so that within a modulation period each sensor element of the sensor element group can receive at least a portion of the reception light and can convert it into different reception signals. The modulation frequency is preferably the modulation frequency of the transmission light in this respect.

More precisely, the light source, for example a laser, transmits the transmission light into the environment in which the object is located. The transmission light beams reflected by the object are received as reception light by the light receiver, for example a camera, and processed further. The light receiver bundles the reception light, e.g. by means of a reception lens, and supplies the reception light to the optical routing layer. The optical routing layer successively and/or alternately supplies the reception light, in particular in a controlled manner, to the sensor elements of the sensor element group. The supply of reception light, i.e. the process in which reception light is supplied to a sensor element, can also be referred to as controlling a sensor element. The sensor elements of the plurality of sensor elements of the sensor element group thus receive at least a portion of the reception light, wherein the received portion of the reception light of one sensor element preferably differs from that of another sensor element. Furthermore, two sensor elements of the sensor element group can each receive portions of the reception light at different points in time.

Later, an “irradiation” of sensor elements is also mentioned. It is understood that such an irradiation also comprises the possibility that—if no reception light is incident—no reception light is incident on the currently irradiated sensor element. The irradiation can therefore be viewed as a possibility of incident reception light being supplied or fed to the respective sensor element. The term “irradiation” can in particular be used synonymously with the term “control”.

The routing layer can further perform the deflection of the reception light based on properties of the transmission light, for example, based on the modulation frequency of the transmission light. By deflecting or redirecting the reception light to the sensor elements instead of blocking the reception light, the reception light is more effectively utilized and no portion of the reception light is wasted.

An increased optical efficiency and an improved signal-to-noise ratio (SNR) are in particular achieved. Measurements can thereby be performed more quickly, whereby the motion blur in a shot by, for example, a camera can in turn be considerably reduced and the sensor response speed can simultaneously be increased.

Furthermore, due to the very fast optical routing or active directing of the reception light to the individual sensor elements of the sensor element group, e.g. in comparison to lock-in pixels, the processing of modulation frequencies of, for example, 1 GHz, 5 GHz, 10 GHz and/or more than 10 Ghz becomes possible since the modulation frequency no longer depends on the transport speed of the charge carriers in the semiconductor. Due to the high modulation frequencies, an improved depth resolution can be achieved. Furthermore, due to the operation of the routing layer, conventional image sensors can be used for an optoelectronic sensor in accordance with the invention so that expensive special image sensors are not required. Furthermore, it is possible to retrofit existing systems or sensors with a corresponding routing layer in a simple manner.

Further aspects of the invention are explained in the following.

A sensor element group in particular processes the information associated with a picture element. A sensor element group can in particular comprise any desired number of sensor elements and preferably, however, two, three or four sensor elements. A sensor element can, for example, be a CMOS sensor (e.g. a 4T CMOS sensor), a CCD sensor, or another suitable sensor.

The reception light incident on the sensor elements is converted by the sensor elements into reception signals, preferably electrical reception signals, that can be used for the determination of a TOF of the transmission light, i.e, a time required for traveling twice the distance between the optoelectronic sensor and the object in the environment. The reception signals can, for example, be put into relation with one another to determine the TOF of the transmission light. For example, the reception signals that were generated by two sensor elements in the same cycle can be put into relation with one another and can preferably be subtracted from one another. The difference of two reception signals can be used in a mathematical procedure to determine the TOF. However, the reception signals can also be put into relation with one another and/or compared to one another in a different manner in order to determine the TOF of the transmission light.

The TOF of the transmission light is in particular determined in an indirect manner, For this purpose, the different portions of the reception light incident on the separate sensor elements are converted into different reception signals on the basis of which the TOF of the transmission light can be determined in an indirect manner,

Further embodiments of the invention can be seen from the description, from the dependent claims, and from the drawings,

In accordance with a first embodiment, the image sensor comprises a two-dimensional detector array having sensor elements and/or sensor element groups of the same kind. i.e. the sensor elements of a sensor element group and/or the sensor element groups are identical or have the same technical design. For example, the two-dimensional detector array can comprise a conventional RGB image sensor without a color filter layer. The image sensor can further, for example, comprise CCD array sensors, CMOS sensors, or any other suitable type of sensor. A corresponding image sensor can thus be implemented in a simple manner since conventional rather than special image sensors or detector arrays can be used.

In accordance with a further embodiment, the routing layer comprises a plurality of partitions that are each associated with a sensor element group, wherein each of the plurality of partitions supplies the reception light at least substantially only to the sensor elements of the sensor element group associated with a partition. A partition is in particular a delimited and/or independent part of the routing layer. The partition can, for example, be square or rectangular in a plan view. The size of the partition can be at least substantially the size of the sensor element group associated with the partition. A partition can in this respect be an independent functional unit that can execute the functions of the routing layer independently of the other partitions of the routing layer. A partition can provide the function of bundling the reception light and/or supplying it to the sensor elements of the associated sensor element group. The partition of the routing layer can, due to its small size, allow a rapid switching between the individual sensor elements when supplying reception light. The processing of particularly high modulation frequencies is thus made possible. Furthermore, in the event of a failure and/or a malfunction of a partition, the operation of the still functional partitions of the routing layer can continue unimpeded. The number of partitions of the routing layer is preferably dependent on and in particular equal to the number of sensor element groups of the image sensor.

In accordance with a further embodiment, the routing layer is mechanically coupled to the image sensor or fastened to the image sensor. The routing layer can, for example, be applied directly to the image sensor or be fastened at a small distance, e.g. a maximum of 5 mm, 3 mm, or 2 mm, from the image sensor. Due to the small distance, the reception light can only be supplied to individual sensor elements without larger portions of the reception light being incident on sensor elements that are currently not to be irradiated. The routing layer can in particular comprise electrical control lines that enable the control of the routing layer.

In accordance with a further embodiment, the routing layer comprises a first and a second layer, wherein the second layer is configured to supply the reception light successively and/or alternately to the sensor elements of the sensor element group. The first and second layer of the routing layer can have different functions, wherein the first layer can receive the reception light and forwards it, preferably in bundled form, to the second layer that successively supplies the reception light, e.g. in a predefined sequence, to the sensor elements of the sensor element group, The first and second layer of the routing layer can further be implemented as one assembly. For example, the two layers are implemented as one assembly in the manufacturing process. Alternatively, it is also possible for the routing layer to comprise only one layer that performs all the functions of the first and second layer.

In accordance with a further embodiment, the first and/or the second layer comprises/comprise a plurality of lenses. For example, each partition of the routing layer comprises one lens, in particular only one lens. The lenses can, for example, bundle and/or intentionally deflect the reception light. The lenses can in particular have a concave, convex, and/or another suitable shape, with the lenses preferably being concave.

In accordance with a further embodiment, the first layer is configured to direct the reception light to the second layer, wherein the second layer can be electrically controlled to supply the reception light successively and/or alternately to the sensor elements of the sensor element group. The first layer of the routing layer can direct and/or shape the reception light, preferably by means of the mentioned lenses, and can supply the reception light to the second layer. The second layer can be electrically controlled, e.g. by means of an electrical control. The electrical control can be configured to define a deflection direction of the reception light and in particular to alternately deflect the reception light in two different directions. Furthermore, the electrical control can be configured, in particular in the case of more than two sensor elements per sensor element group, to define a sequence in which the sensor elements of the sensor element group are irradiated with the reception light. The second layer can effect the deflection of the reception light to the individual sensor elements, for example, by means of micromirrors and/or by prisms, in which the refractive index and thus the direction of propagation of the reception light are electrooptically changed, and/or other suitable means, The refractive index can in particular be changed and/or set by a variety of electro-optic effects. For example, phase-change materials that e.g. switch between crystalline and amorphous, TCOs (transparent conductive oxides) that e.g. change a plasma frequency and thus the refractive index by applying a voltage and/or by changing the charge carrier density, and/or organic electro-optic materials such as OAST can be used. In general, in the field of photonic integrated optics, a variety of materials, approaches, and electro-optic effects are known that can be used for the fast switching of light. The second layer can comprise the above-mentioned means.

The irradiation of the individual sensor elements of a sensor element group can thus be adapted by means of the electrical control and can in particular be adapted to properties of the reception light and/or transmission light, For example, a time duration of the irradiation of a sensor element and a sequence of the irradiation of the sensor elements of the sensor element group can be adapted to the modulation frequency of the transmission light and/or reception light, to the number of sensor elements per sensor element group, and/or to the sensor element type.

The routing layer or the firstayer or the second layer can preferably not comprise any moving parts. The directing of the reception light then e.g. only takes place via electro-optic effects and the like.

The electrical control can further be configured to control the deflection of the reception light such that at least a portion of the reception light is incident on at least one sensor element of the sensor element group at any point in time of the irradiation. In particular, at least 50% or at least 80% of the reception light that is e.g. incident on a partition of the routing layer is supplied to only one sensor element. The routing layer is preferably configured not to block any reception light (except for e.g. unavoidable reflections and the like). The routing layer is thus permanently light-permeable for the reception light, whereby ultimately more reception light reaches the image sensor.

The electrical control preferably controls the deflection of the reception light such that a transition between the irradiation of one sensor element of the sensor element group and another sensor element of the sensor element group, i.e. a time period in which two sensor elements of the sensor element group are simultaneously irradiated, is of a short time duration and in particular shorter than e.g. 10 ns or 0.1 ns. It is hereby achieved that a reception signal converted by one sensor element of the sensor element group is substantially different from a reception signal converted by another sensor element of the sensor element group and/or substantially different portions of the reception light are detected by the sensor elements of the sensor element group. Nevertheless, it is also possible that two or more sensor elements of the sensor element group are simultaneously irradiated for a longer time duration than the one mentioned above.

Furthermore, the electrical control can be configured such that the reception light is cyclically supplied to the sensor elements of the sensor element group, i.e. in a predefined and/or recurring sequence. Each sensor element of the sensor element group is thus preferably irradiated at least once and in particular exactly once within a modulation period of a plurality of modulation periods. A single irradiation of a sensor element within the modulation period is present if the sensor element is irradiated without interruption for a certain time duration within the modulation period and no further irradiation takes place within the same modulation period.

In accordance with a further embodiment, the first layer is configured to selectively change the polarization of the reception light (i.e., for example, in response to a control signal of the electrical control) and the second layer is configured to supply the reception light to different sensor elements of the sensor element group depending on the polarization of the reception light. For example, the emitted transmission light and thus the reception light correspondingly reflected by the object in the environment can have a predetermined polarization. The first layer of the routing layer can change the polarization of the reception light incident on the first layer. For example, the first layer can convert left-handed circularly polarized reception light into right-handed circularly polarized reception light or vice versa for predetermined time durations. To change the polarization, the first layer can comprise an optically active layer and/or any other means suitable for this purpose. The polarization of the reception light can further be or comprise a linear polarization, a circular polarization, or any other kind of polarization.

The second layer can further be configured to deflect the reception light depending on the polarization of the reception light. The second layer can in particular comprise polarization-dependent lenses, metasurfaces, and/or polarization filters. Metasurfaces that control the so-called Pancharatnam-Berry phase, and thus enable a polarization-dependent beam shaping and beam deflection of a light beam, are known from the literature (e.g., “Multifunctional Metamirror: Polarization Splitting and Focusing,” ACS Photonics 2018 5 (5), DOI: or “Reflective metalens with sub-diffraction-limited and multifunctional focusing,” Sci Rep 7, 12632 (2017). DOI: 10.1038/s41598-017-13004-z). In the first layer, a temporary change in the polarization of the reception light can, for example, be made in each modulation period. Due to the polarization-dependent deflection of the reception light in the second layer, the reception light can thus be successively and/or alternately supplied to different sensor elements.

The second layer can generally be configured to deflect the reception light depending on its polarization, amplitude, and/or wavelength. The first layer can in this respect make a corresponding change to the reception light.

The electrical control can furthermore be configured to control at least some of the functions or all of the functions of the optoelectronic sensor. The electrical control can in particular determine the distance from an object and can output the distance as a distance signal. The distance signal can e.g. also include a depth map, wherein e.g. a separate distance value is determined for each sensor element group and is entered into the depth map (by the electrical control).

In accordance with a further embodiment, the sensor elements of the sensor element group are arranged in one row or in two or more rows, wherein each sensor element of the sensor element group is in physical contact with another sensor element of the sensor element group directly or at least via a sensor element.

For example, the sensor elements of the sensor element group are arranged next to one another along a straight line. A row can in this respect be oriented vertically, horizontally or in another direction. Furthermore, the sensor elements of the sensor element group can also be arranged in two or more rows disposed directly next to one another. For example, with four sensor elements per sensor element group, the sensor elements can be arranged in a 2×2 grid. In such an arrangement, the routing layer can irradiate the sensor elements one after another, e.g. clockwise or counterclockwise in a plan view.

In accordance with a further embodiment, the image sensor is configured to perform a readout of the sensor elements, and in particular of charge quantities accumulated by the sensor elements, after a predetermined number of irradiation cycles and/or separately for the sensor elements of the sensor element group. In other words, the charge accumulated by a sensor element is detected or evaluated only after a predetermined number of modulation periods. One irradiation cycle can correspond to one modulation period. For this reason, modulation periods are also referred to in the following.

With the readout or the evaluation of the accumulated charge, the reception signal is generated. The accumulated charge quantity is preferably related to the amount of light of the reception light received by a sensor element. The readout or evaluation after a larger number of modulation periods has the advantage that larger charge quantities can be accumulated that can be read out more easily and an improved SNR of the reception signal is achieved. The predetermined number of irradiation cycles or modulation periods is preferably selected such that a measurement value acquisition time duration results that is significantly greater, and in particular by a factor of 1,000, 10,000 or 100,000 greater, than the duration of a modulation period

$${t}_{Modulation period} = \frac{1}{Modulation frequency} ,$$

The optoelectronic sensor is therefore preferably configured to generate the reception signal only after at least 1,000, 10,000 or 100,000 irradiation cycles. The predetermined number of irradiation cycles/modulation periods is in particular selected such that the corresponding SNR of the reception signal exceeds a predefined threshold value.

In accordance with a further embodiment, the image sensor is configured to perform the readout of the charge quantities accumulated by the sensor elements at least substantially at the same time for the sensor elements of the sensor element group, for example by a parallel readout of a plurality of or all of the sensor elements of the image sensor and/or a plurality of or all of the sensor element groups of the image sensor. For this purpose, the image sensor can be configured to perform a so-called “global shutter”, Alternatively, a serial readout in the form of a “rolling shutter” is also possible.

In accordance with a further embodiment, the sensor is configured to determine a distance from objects in the environment based on at least four or at least eight reception signals that are generated by two sensor elements of the same sensor element group. The distance can in particular be determined by means of a four-phase process. Two reception signals E_{1,1}, E_{1,2} can, for example, be generated by the two sensor elements in a first measurement process. A respective reception signal in this respect indicates the intensity or amount of the reception light received by the respective sensor element during a measurement process or a predetermined number of modulation periods. A sensor element is in particular controlled for the time duration

$$t = \frac{1}{2} \cdot {t}_{Modulation period} \cdot {n}_{Mod}$$

during a measurement process, i.e. a sensor element is ready to receive for this time duration during a measurement process, where Mod corresponds to a predetermined number of modulation periods. The point in time and/or the time duration of the irradiation of a sensor element is in particular determined by the point in time of the change of the deflection direction that is determined by the modulation function. The modulation function is preferably a square wave function that preferably has an edge change after every 180° or π. Depending on the steepness of the edge change, it can further be defined for which time duration two sensor elements are simultaneously irradiated with reception light. Furthermore, in a subsequent second, third and fourth measurement process, the reception signals E_{2,1}, E_{2,2}, E_{3,1}, E_{3,2}, E_{4,1}, E_{4,2} can be generated, wherein the modulation function for the second, third and fourth measurement process is offset by 90° or π/2 in each case. The phase shift Φ_{TOF} of the reception light with respect to the transmission light for the respective sensor element group can then be determined by means of cross-correlation as follows, where E₁, E₂, E₃ and E₄ represent the difference of the reception signals of the two sensor elements generated in a corresponding measurement process, i.e. E₁=E_{1,1}−E_{1,2}, E₂=E_{2,1}−E_{2,2}, E₃=E_{3,1}−E_{3,2} and E₄=E_{4,1}−E_{4,2}:

$${Φ}_{TOF} = {tan}^{- 1} ( \frac{{E}_{4} - {E}_{2}}{{E}_{1} - {E}_{3}} )$$

The distance from the object (or from a point of the object) can then be determined in a known manner from the phase shift Φ_{TOF} and, if necessary, from the amplitude and/or the intensity offset between the transmission light and the reception light.

It is generally also possible to determine the phase shift by means of a 3-phase measurement, wherein three sensor elements can be used in this case.

In another embodiment of the invention, four sensor elements can also be used for the determination of the phase shift. In accordance with this further embodiment, the sensor is configured to determine a distance from objects in the environment based on at least four reception signals from four sensor elements of the same sensor element group. The four sensor elements can in this respect be irradiated with reception light one after another and in particular at least substantially only individually. The distance can therefore be determined by means of a four-phase process. Four reception signals E₁, E₂, E₃ and E₄ can be generated by the four sensor elements. A respective reception signal in this respect indicates the intensity or amount of the modulated reception light received by the respective sensor element during a predetermined number of modulation periods. The phase shift Φ_{TOF} of the reception light with respect to the transmission light for the respective sensor element group can be determined by means of cross-correlation as follows:

$${Φ}_{TOF} = {tan}^{- 1} ( \frac{{E}_{4} - {E}_{2}}{{E}_{1} - {E}_{3}} )$$

From the phase shift Φ_{TOF}, the distance from the object (or from a point of the object) can then be determined in a known manner.

In another embodiment of the invention, four sensor elements can likewise be used for the determination of the phase shift. For example, with four sensor elements per sensor element group, during an irradiation cycle, a first and a second sensor element of the sensor element group are irradiated with reception light in a first modulation period, while a third and a fourth sensor element are irradiated with reception light in a second modulation period. The first and third sensor element or the second and fourth sensor element are in particular irradiated with a substantially identical portion of the reception light so that the corresponding reception signals generated by the sensor elements are also substantially the same. For the first and third sensor element or the second and fourth sensor element, a so-called “binning” can then take place, i.e. the signals of the respective sensor elements are combined. As stated above, the sensor elements can be irradiated with reception light for n_{Mod} modulation periods and a corresponding number of irradiation cycles until corresponding reception signals are generated. The third and fourth sensor element are to be understood as redundant sensor elements by which, for example, deviations of the sensor elements caused by manufacturing can be compensated. Alternatively, during an irradiation cycle, the first and third sensor element can also be simultaneously irradiated with reception light in a first irradiation phase and the second and fourth sensor element can be simultaneously irradiated with reception light in a second irradiation phase. The determination of the phase shift—in the case of four sensor elements per sensor element group—can take place as in the case with two sensor elements, wherein, for example, the reception signal E_{1,1} is determined during a first measurement process on the basis of the reception signals generated by the first and third sensor element, for example on the basis of an average value of the reception signals generated by the second and fourth sensor element, and the reception signal E_{1,2} is determined on the basis of the reception signals generated by the second and fourth sensor element, for example on the basis of an average value of the reception signals generated by the second and fourth sensor element. The reception signals E_{2,1}, E_{2,2}, E_{3,1}, E_{3,2}, E_{4,1} and E_{4,2} can be determined accordingly in a second, third and fourth measurement process.

It is also possible that the four sensor elements successively receive at least substantially different reception signals during an irradiation cycle, i.e. each sensor element is irradiated at least once during a modulation period, so that each sensor element generates a different reception signal. In such a case, the duration of the irradiation of the individual sensor elements of a sensor element group can in particular also differ from one another during an irradiation cycle.

After generating a reception signal or after a measurement process, the sensor elements can be reset to enable a new measurement process that is unaffected by a previous signal conversion performed by the sensor element.

In accordance with a further embodiment, the light source is configured to transmit the transmission light in an amplitude-modulated manner. For example, an oscillating voltage signal (e.g. the transmission signal), which comprises the modulation frequency, can be supplied to the light source by means of a voltage oscillator to generate the amplitude-modulated transmission light. The modulation frequency of the amplitude-modulated transmission light can in particular comprise a frequency of more than 1 GHz, 5 GHz, 10 GHz and/or 50 GHz.

The invention further relates to a method for an optoelectronic sensor for distance measurement, said method comprising:
a transmission signal being converted into transmission light and the transmission light being transmitted into an environment;
transmission light reflected by objects in the environment being received as reception light by a light receiver that has a routing layer and an image sensor comprising a plurality of sensor elements, and the reception light being converted into a reception signal by the sensor elements, wherein at least two sensor elements are part of a sensor element group and the optical routing layer supplies the reception light successively and/or alternately to the sensor elements of the sensor element group.

In accordance with a further embodiment, each sensor element is controlled/irradiated for an equal time duration and the time duration of the irradiation of a sensor element (in the case of two sensor elements per sensor element group) is in particular determined as follows:

$${T}_{Irradiation} = \frac{{t}_{Modulation period}}{2} ,$$

where t_{Modulation period} is a time duration of a modulation period of the transmission signal and/or reception signal. For four sensor elements per sensor element group, the divisor in the above equation could also be “4”. In general, for “n” sensor elements per sensor element group, the divisor in the above equation can also be “n”.

The invention further relates to a method for manufacturing an optoelectronic sensor for distance measurement in accordance with any one of the above embodiments, said method comprising:

the image sensor and the routing layer being manufactured as light receivers in the same manufacturing process. The image sensor and the routing layer can in particular be produced in the same manufacturing process by means of consecutive lithography processes.

Furthermore, the routing layer can be positioned in the manufacturing process so that the reception light is first incident on the routing layer and is forwarded or conducted by the routing layer to the image sensor, In conventional image sensors, such as RGB image sensors, a color filter layer, which filters the colors of the reception light ; is installed in front of the actual image sensor. In a manufacturing process of such image sensors, a routing layer can be installed instead of such a color filter layer. Consequently, the optoelectronic sensor can be manufactured without an expensive special manufacturing process.

The statements on the optoelectronic sensor apply accordingly to the method for the optoelectronic sensor and the manufacturing method; this in particular applies with respect to advantages and embodiments. It is furthermore understood that all the features and embodiments mentioned herein can be combined with one another, unless stated otherwise.

The invention will be presented purely by way of example with reference to the drawings in the following. There are shown, in a schematic view in each case:

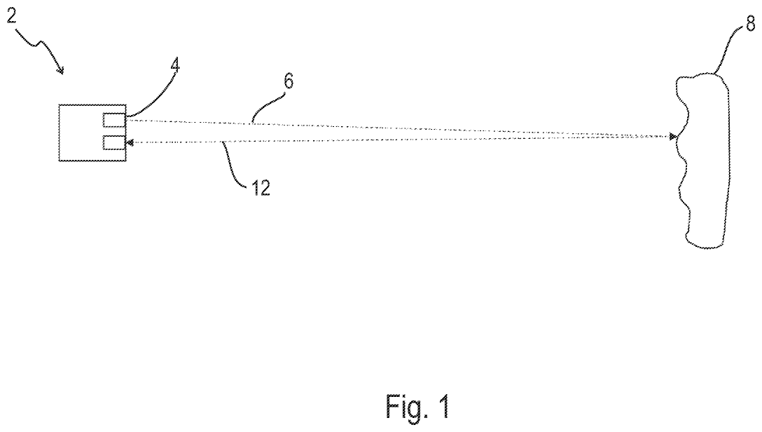

FIG. 1 an optoelectronic sensor for distance measurement;

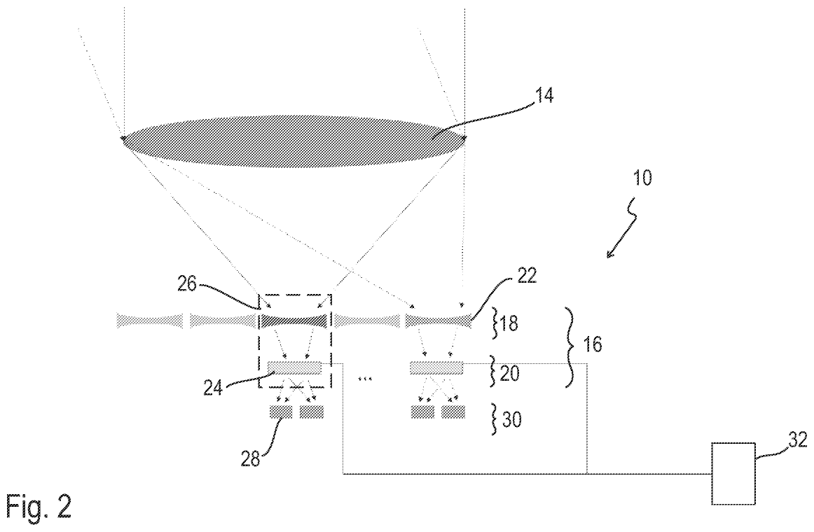

FIG. 2 an embodiment of a light receiver for an optoelectronic sensor for distance measurement;

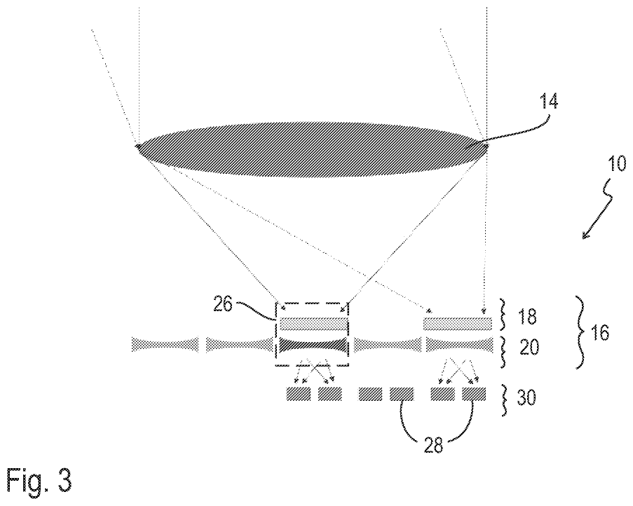

FIG. 3 a further embodiment of a light receiver for an optoelectronic sensor for distance measurement; and

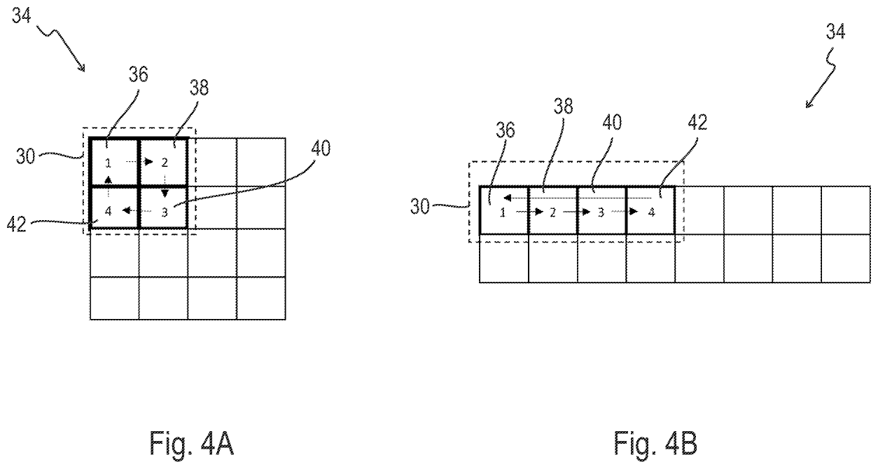

FIGS. 4A, 4B a section of an image sensor.

FIG. 1 shows an optoelectronic sensor 2 for distance measurement. The optoelectronic sensor 2 comprises a light source 4 that converts an electrical transmission signal into transmission light 6 and transmits the transmission light 6 into an environment in which an object 8 is located. Transmission light 6 reflected by the object 8 is received by a light receiver 10 of the optoelectronic sensor 2 as reception light 12, wherein the reception light 12 is converted into an electrical reception signal by the light receiver 10. The light receiver 10 is, for example, shown in FIG. 2.

As shown in FIG. 2, the reception light 12 is converted into electrical reception signals by two sensor elements 28 of a sensor element group 30 of the light receiver 10, wherein each sensor element 28 of the sensor element group 30 generates a different reception signal.

The transmission light 6, and thus also the reception light 12, are preferably amplitude-modulated, wherein the amplitude-modulated transmission light 6 can have a modulation frequency f of more than 1 GHz, 5 GHz, 10 GHz and/or 50 GHz.

FIG. 2 shows the light receiver 10 of the optoelectronic sensor 2 for distance measurement. The light receiver 10 comprises a reception lens 14 that receives the modulated reception light 12 and forwards it to a routing layer 16. The routing layer 16 comprises a first layer 18 and a second layer 20. The first layer 18 comprises a plurality of concave lenses 22, and in particular microlenses, that receive the reception light 12 forwarded by the reception lens 14 and direct it to the second layer 20. The second layer comprises a plurality of sections 24 that are each associated with a lens 22 of the first layer 18. A lens 22 of the first layer 18 and an associated section 24 of the second layer 20 together form a partition 26 of the routing layer 16. A section 24 (i.e. a part of the partition 26) of the second layer 20 receives the reception light 12 from an associated lens 22 of the first layer 18 and directs the reception light 12 successively and alternately to the sensor elements 28 of a sensor element group 30 in a controlled manner. The directing of the reception light 12 can e.g, take place by electro-optic mechanisms. In this respect, the second layer 20 is connected to an electrical control 32 so that the reception light 12 can be supplied to the sensor elements 28 of the sensor element group 30 in an electrically controllable manner.

The modulated reception light 12 is repeatedly and successively supplied to two sensor elements 28 that generate respective reception signals E_{1,1} and E_{1,2} from the reception light after a predetermined number of repetitions (i.e. irradiation cycles) or after a first measurement process. After three further subsequent measurement processes, the corresponding reception signals E_{2,1}, E_{2,2}, E_{3,1}, E_{3,2}, E_{4,1}, E_{4,2} furthermore result that differ from one another. Based on the reception signals, difference signals E₁, E₂, E₃ and E₄ are formed for the respective first to fourth measurement processes, where E₁=E_{1,1}−E_{1,2}, E₂=E_{2,1}−E_{2,2}, E₃=E_{3,1}−E_{3,2} and E₄=E_{4,1}−E_{4,2}.

The phase shift Φ_{TOF} of the reception light 12 with respect to the transmission light 6 for the sensor element group 30 of the two sensor elements 28 can then be determined by means of the following formula:

$${Φ}_{TOF} = {tan}^{- 1} ( \frac{{E}_{4} - {E}_{2}}{{E}_{1} - {E}_{3}} )$$

Based on the phase shift Φ_{TOF} between the reception signal and the transmission signal, the distance between the optoelectronic sensor 2 and the object 8 can be calculated.

FIG. 3 shows a further embodiment of a light receiver 10 for an optoelectronic sensor 2 for distance measurement, in which embodiment a polarization of the transmission light 6 and/or the reception light 12 is used to selectively direct the reception light 12 to the sensor elements 28. The design of the light receiver 12 in

FIG. 3 substantially corresponds to the design of the light receiver 12 in FIG. 2, but differs in the design of the optical routing layer 16.

The optical routing layer 16 used in FIG. 3 likewise comprises a first layer 18 and a second layer 20. The first layer 18 generates and/or changes the polarization of the reception light 12 and forwards the reception light 12 to the second layer 20. For example, the first layer 18 can manipulate the reception light 12 such that the reception light 18 forwarded to the second layer 20 has a polarization alternating between left-handed circular polarization and right-handed circular polarization. The second layer 20, which comprises a plurality of polarization-dependent lenses, can supply the reception light 12 to the two sensor elements 28 of the sensor element group 30 depending on the polarization of the reception light 12. It is also conceivable that the image sensor comprises three, four or more than four sensor elements and the polarization is arbitrarily selected and/or changed by controllable half-wave plates (HWP) and quarter-wave plates (QWP) (as known, for example, in fiber polarization controllers) and the second layer, for example a metasurface, then passively implements a deflection to the different pixels.

FIG. 4A shows a section of an image sensor 34. In the section, four sensor element groups 30 are shown, each having four sensor elements 28 per sensor element group 30. Each sensor element group 30 comprises two rows with a respective two sensor elements 28 per row. In a first irradiation phase, the routing layer 16 supplies the reception light 12 to the first sensor element 36 for a time duration t_{Irradiation}=1/2 ·t_{Modulation period} or t_{Irradiation}=1/4·t_{Modulation period} . In a subsequent second irradiation phase, the routing layer 16 supplies the reception light 12 to the second sensor element 38 for the time duration t_{Irradiation}. In a subsequent third irradiation phase, the routing layer supplies the reception light 12 to the third sensor element 40 for the time duration t_{Irradiation}. In a subsequent fourth irradiation phase, the routing layer supplies the reception light 12 to the fourth sensor element 42 for the time duration t_{Irradiation}. The deflection of the reception light 12 to the different sensor elements 28 in this respect takes place “clockwise” as shown in FIG. 4. However, the deflection of the reception light 12 to the different sensor elements 28 can also take place “counterclockwise”. The deflection of the reception light 12 to the different sensor elements 28 can in particular take place in any desired manner.

A further section of an image sensor 34 is shown in FIG. 4B. In this embodiment, the sensor elements 28 of the sensor element group 30 are arranged next to one another in a row. In this respect, the deflection of the reception light 12 by the routing layer 16 takes place from left to right, starting at the first sensor element 36 up to the fourth sensor element 42. When the reception light 12 has been deflected to the fourth sensor element 42 and an irradiation cycle, i.e. two modulation periods or one modulation period, is completed, the reception light 12 is deflected such that it is again incident on the first sensor element 36 in a subsequent modulation period or in a subsequent irradiation cycle. The deflection of the reception light 12 can furthermore also take place from left to right or in any other suitable manner.

For t_{Irradiation}=1/4·t_{Modulation period}, the distance can be determined by means of the four-phase method explained above.

### REFERENCE NUMERAL LIST

2 optoelectronic sensor
4 light source
6 transmission light
8 object
10 light receiver
12 reception light
14 reception lens
16 routing layer
18 first layer
20 second layer
22 lenses
24 sections
26 partitions
28 sensor elements
30 sensor element group
32 electrical control
34 image sensor
36 first sensor element
38 second sensor element
40 third sensor element
42 fourth sensor element

1. An optoelectronic sensor for distance measurement, comprising:
a light source that is configured to convert a transmission signal into transmission light and to transmit the transmission light into an environment;
a light receiver that receives transmission light reflected by objects in the environment as reception light, wherein the light receiver has an optical routing layer,
wherein the light receiver has an image sensor comprising a plurality of sensor elements, wherein the sensor elements are configured to convert reception light into reception signals,
wherein at least two sensor elements are part of a sensor element group,
wherein the routing layer is configured to supply the reception light successively and/or alternately to the sensor elements of the sensor element group.

2. The optoelectronic sensor in accordance with claim 1,
wherein the image sensor comprises a two-dimensional detector array having sensor elements and/or sensor element groups of the same kind.

3. The optoelectronic sensor in accordance with claim 1,
wherein the routing layer comprises a plurality of partitions that are each associated with a sensor element group; wherein each of the plurality of partitions supplies the reception light at least substantially only to the sensor elements of the sensor element group associated with a partition.

4. The optoelectronic sensor in accordance with claim 1,
wherein the routing layer is mechanically coupled to the image sensor or fastened to the image sensor.

5. The optoelectronic sensor in accordance with claim 1,
wherein the routing layer comprises a first and a second layer, wherein the second layer is configured to supply the reception light successively and/or alternately to the sensor elements of the sensor element group.

6. The optoelectronic sensor in accordance with claim 5,
wherein the first and/or the second layer comprises/comprise a plurality of lenses.

7. The optoelectronic sensor in accordance with claim 5,
wherein the first layer is configured to direct the reception light to the second layer, wherein the second layer can be electrically controlled to supply the reception light successively and/or alternately to the sensor elements of the sensor element group.

8. The optoelectronic sensor in accordance with claim 5,
wherein the first layer is configured to selectively change the polarization of the reception light and the second layer is configured to supply the reception light to different sensor elements of the sensor element group depending on the polarization of the reception light.

9. The optoelectronic sensor in accordance with claim
wherein the image sensor is configured to perform a readout of charge quantities accumulated by the sensor elements after a predetermined number of irradiation cycles and/or separately for the sensor elements of the sensor element group.

10. The optoelectronic sensor in accordance with claim 9,
wherein the optoelectronic sensor is configured to generate the reception signal only after at least 1,000 10,000 or 100,000 irradiation cycles.

11. The optoelectronic sensor in accordance with claim 9,
wherein the image sensor is configured to perform the readout of the charge quantities accumulated by the sensor elements substantially at the same time for the sensor elements of the sensor element group.

12. The optoelectronic sensor in accordance with claim 1,
wherein the sensor is configured to determine a distance from the objects in the environment based on at least eight reception signals E_{1,1}, E_{1,2}, E_{2,1}, E_{2,2}, E_{3,1}, E_{2,2}, E_{4,1} and E_{4,2} that are generated by two sensor elements of the same sensor element group.

13. The optoelectronic sensor in accordance with claim 12,
wherein a phase shift Φ_{TOF} of the reception light with respect to the transmission light is determined for the respective sensor element group based on the formula
$${Φ}_{TOF} = {tan}^{- 1} ( \frac{( {E}_{4 , 1} - {E}_{4 , 2} ) - ( {E}_{2 , 1} - {E}_{2 , 2} )}{( {E}_{1 , 1} - {E}_{1 , 2} ) - ( {E}_{3 , 1} - {E}_{3 , 2} )} ) ,$$
where E_{1,1} and E_{1,2} are the reception signals that are generated by the two sensor elements after a first measurement process, E_{2,1} and E_{2,2} are the reception signals that are generated by the two sensor elements after a second measurement process, E_{3,1} and E_{3,2} are the reception signals that are generated by the two sensor elements after a third measurement process, and E_{4,1} and E_{4,2} are the reception signals that are generated by the two sensor elements after a fourth measurement process. 10

14. The optoelectronic sensor in accordance with claim 1,
wherein the sensor is configured to determine a distance from the objects in the environment based on at least four reception signals from four sensor elements of the same sensor element group.

15. The optoelectronic sensor in accordance with claim 14,
wherein a phase shift Φ_{TOF} of the reception light with respect to the transmission light is determined for the respective sensor element group based on the formula
$${Φ}_{TOF} = {tan}^{- 1} ( \frac{{E}_{4} - {E}_{2}}{{E}_{1} - {E}_{3}} ) ,$$
where E₁, E₂, E₃ and E₄ are the reception signals of the sensor elements (28).

16. The optoelectronic sensor in accordance with claim 1,
wherein the light source is configured to transmit the transmission light in an amplitude-modulated manner.

17. The optoelectronic sensor in accordance with claim 16,
wherein the light source is configured to use a frequency of more than 1 GHz, 5 GHz, 10 GHz or 50 GHz for the amplitude modulation.

18. A method for an optoelectronic sensor for distance measurement, said method comprising:
a transmission signal being converted into transmission light and the transmission light being transmitted into an environment;
transmission light reflected by objects in the environment being received as reception light by a light receiver that has a routing layer and an image sensor comprising a plurality of sensor elements, and the reception light being converted into reception signals by the sensor elements, wherein at least two sensor elements are part of a sensor element group and the optical routing layer supplies the reception light successively and/or alternately to the sensor elements of the sensor element group.

19. A method for manufacturing an optoelectronic sensor for distance measurement, the optoelectronic sensor comprising:
a light source that is configured to convert a transmission signal into transmission light and to transmit the transmission light into an environment;
a light receiver that receives transmission light reflected by objects in the environment as reception light, wherein the light receiver has an optical routing layer,
wherein the light receiver has an image sensor comprising a plurality of sensor elements, wherein the sensor elements are configured to convert reception light into reception signals,
wherein at least two sensor elements are part of a sensor element group,
wherein the routing layer is configured to supply the reception light successively and/or alternately to the sensor elements of the sensor, said method comprising:
the image sensor and the routing layer being manufactured as light receivers in the same manufacturing process.
